(19) United States
(12) Patent Application Publication
(10) Pub. No.: US 2026/0304082 A1
(43) Pub. Date: Oct. 1, 2026

(54) MAP-MATCHING BASED MESSAGE ROUTING METHOD, SYSTEM, COMPUTER PROGRAM PRODUCT AND COMPUTER READABLE MEDIUM FOR IMPLEMENTING THE METHOD

(71) Applicant: Commsignia Kft., Attala (HU)

(72) Inventors: Szabolcs Nováczki, Budapest (HU); András Váradi, Budapest (HU); András Wippelhauser, Pilisvörösvár (HU)

(21) Appl. No.: 19/477,866

(22) PCT Filed: Apr. 26, 2024
(86) PCT No.: PCT/HU2024/050029

§ 371 Date: Oct. 23, 2025

(30) Foreign Application Priority Data
Apr. 26, 2023 (HU) P2300131

(51) Int. Cl. H04W 4/44; H04W 4/02; H04W 4/029

(52) U.S. Cl. CPC H04W 4/44; H04W 4/025; H04W 4/029

(57) ABSTRACT

The invention relates to a method for message routing. The method comprises receiving, by a message routing center and from at least one source entity, an incoming message including traffic-related information. The method further comprises transmitting, by the message routing center and to at least a receiving entity, an outgoing message containing the traffic-related information if the incoming message is deemed relevant for the receiving entity. Relevance is determined by the message routing center based on map-matched location of the source entity and the receiving entity. The message routing center utilizes a message routing table and the method further comprises calculating values of the message routing table. Each value of the message routing table corresponds to relevance between a source entity and a receiving entity.

### TECHNICAL FIELD

The invention relates to a method and a system for map-matching based message routing. The invention relates also to a computer program product and computer readable medium implementing the method.

Vehicle-to-everything (V2X) technology allows entities participating in ground transport to share and receive various types of information in a distributed manner preferably via standardised message formats in real-time over dedicated radio channels. These pieces of information may include, e.g., the type of the sender device (a device of a sharing entity), absolute location, dimensions, heading, speed and other main properties. V2X messages may also contain confidence values for some of the information shared. V2X messages are digitally signed, and signers also send certificates proving their authentication. Next generation systems can also be able to send information about external objects and entities, such as non-connected vehicles, pedestrians, animals, etc. by broadcasting their onboard sensor output. The main objective of the technology is to enhance traffic safety. In recent times, the penetration of V2X-enabled devices has dynamically increased and the rate of the spread of technology is expected to further increase. The final aim is to integrate each relevant participant, including pedestrians, cyclists, or e-scooter users.

Two main directions have started to evolve that dramatically increase the amount of shared information within a V2X ecosystem. First, the percentage of V2X-enabled participants has continuously increased in the past few years as car manufacturers have started making V2X an integral part of their newest models. However, as most of the participants in transport are equipped with V2X technology, there tends to be a growing demand of integrating non-V2X entities, especially in areas where, according to the statistics, the traffic is more dangerous than the average.

To achieve this objective, an increasing number of roadside units (RSUs) have started to be equipped with smart sensors that usually perform object detection and tracking as well, which can serve as an input to dedicated sensor sharing messages (e.g., Collective Perception Message in European and Sensor Data Sharing Message in the US regions). Furthermore, as most vehicles are equipped with several sensors having various safety functions, their detections may also be shared within these standardised messages, providing a receiving V2X participant with an enormous amount of information.

### BACKGROUND ART

The information available via various sources (e.g., vehicles, TMCs, RSUs, etc.) need to be connected with relevant recipients.

FIG. 1 illustrates a prior art solution, wherein vehicles within a predetermined relevance area 10 are connected to each other to directly communicate, i.e., to share and receive data and available information. The predetermined area according to this example has a circular shape indicated by a dotted line around an ego vehicle, wherein the radius of the circle corresponds to a relevance range (relevance distance). FIG. 1 shows a part of a highway having two lanes on each side of the road, and the lanes leading to opposite directions are separated by a physical barrier 12 as usual for highways.

There are two major problems that are apparent from FIG. 1. First, due to the circular shaped relevance area, vehicles that are moving to the opposite direction and are separated by physical barriers 12, therefore cannot affect each other are also connected, which leads to sending, receiving and processing unnecessary messages. Second, there are other vehicles on the same side of the highway, that are outside the relevance area, however, as they move in the same direction, should share information with each other as their messages are relevant for each other.

The above two problems cannot be solved by simply changing the size of the relevance area, e.g., by applying a circular shaped relevance area having smaller or larger diameters. On the one hand, by increasing the size (or diameter) of the relevance area, the number of relevant vehicles left out will decrease, however, the number of irrelevant vehicles (e.g., driving on the other side of the highway in the opposite direction) will increase. I.e., from the perspective of the ego vehicle, relevant but distant vehicles will be covered by the relevance area, however more irrelevant vehicles will also be part of the relevance area. On the other hand, by decreasing the size of the relevance area, the number of irrelevant vehicles will decrease, however, the number of relevant vehicles (e.g., driving on the same side of the highway) will also decrease. I.e., cutting down the number of irrelevant messages received will come with a price of not receiving relevant messages from otherwise relevant other vehicles.

FIG. 2 shows how message routing works in the example of FIG. 1. All the depicted vehicles send messages towards a message routing centre 14, however the ego-vehicle will only receive the ones from within the relevance area. All the other messages will be dropped by the message routing centre instead forwarding them to the ego-vehicle.

As FIG. 3 depicts that the same problems arise with relevance areas 30 having different shapes, e.g., a rectangular relevance area. Furthermore, similar problems may arise in other traffic situations, not only in the case of highways as depicted in FIGS. 1 and 3.

US 2022/0256306 A1 relates to a method for subscribing a mobile device to information on events from a geo-service. However, the document does not disclose the routing of messages originating from other subscribers. US 2022/0408219 A1 relates to method, according to which V2X devices can subscribe to a V2X server and configure their subscription area. The technical solution according to the document leaves the burden to calculate the necessary area to subscribe for, which can be a very computational-heavy task.

In view of the known approaches, there is a need for a method that can route information available from a plurality of information sources to relevant recipients only.

### DESCRIPTION OF THE INVENTION

The primary object of the invention is to provide a method for routing information, especially traffic-related information, which is free of the disadvantages of prior art approaches to the greatest possible extent.

The main problem with having an abundant source of information is that a receiving entity can be overloaded with information, causing possible delays in receiving and processing relevant information, while also wasting time and resources on processing irrelevant information.

A further problem is that a receiving entity may not be aware all the types of information available from specific information sources, furthermore receiving entities might not be clear on what exact information is really relevant for them.

Therefore, an object of the invention is to provide a method and system that collects connects information, mainly traffic-related information from various available information sources such as vehicles, RSUs, etc. and transmits information relevant to the receiving entities.

A further object of the invention is to provide a method and system that allows for limiting the unnecessary communication and data sharing between information sources (source entities) and recipients (receiving entities).

Furthermore, the object of the invention is to provide a non-transitory computer program product for implementing the steps of the method according to the invention on one or more computers and a non-transitory computer readable medium comprising instructions for carrying out the steps of the method on one or more computers.

The objects of the invention can be achieved by the method according to claim 1. The objects of the invention can be further achieved by the system according to claim 10, the non-transitory computer program product according to claim 15, and by the non-transitory computer readable medium according to claim 16. Preferred embodiments of the invention are defined in the dependent claims.

An advantage of the method according to the invention is that it transmits relevant information only between information sources and recipients, thus limiting the unnecessary communication and data sharing between information sources and recipients. By transmitting relevant information only, CPU resources of the receiving entity can be spared.

Relevance of information in traffic systems are usually determined by physical distance between information sources and receiving entities, e.g., if two vehicles are close to each other, the information that each one of them can share might be relevant for the other. It has been recognized that distance alone is not a suitable indicator for relevance, as information shared by a vehicle travelling on one side of a highway might not be relevant for an other vehicle travelling in the opposite direction on the same highway. Said problem of the prior art solutions are schematically illustrated on FIGS. 1-3.

The problem of receiving unnecessary messages is not a real issue if one does not consider limited CPU resources, as the receivers can decide to drop these messages based on filtering logic applied in on-board computing units. However, in most cases limited radio resources are available, therefore transmitting irrelevant messages uses the spectrum unnecessarily, and while these messages are transmitted, relevant messages cannot be, or can be transmitted with significant delays. Moreover, receiving and processing irrelevant messages uses the local computing resources of vehicles unnecessarily, leaving fewer resources to process relevant messages.

Furthermore, determining relevance of a certain piece of information can require a high computing resources, therefore it can be cumbersome to perform it on e.g., an onboard computer of a vehicle that has a limited computational capacity. It has been recognized that by taking over the burden of calculation from the individual entities by a routing centre adapted to route information and messages from source entities to receiving entities leads to a more efficient and effective method and system. As a routing centre can be equipped with a practically unlimited computing capacity, the method and system according to the invention not only results in more accurate relevance calculation, but the routing centre can also be adapted to synthetise or fuse collected information before forwarding it to relevant receiving entities. As a result, the individual receiving entities can be supplied with more relevant and useful information that can be more directly used by the receiving entity, e.g., without extensive calculations such as map-matching.

### BRIEF DESCRIPTION OF THE DRAWINGS

Preferred embodiments of the invention are described below by way of example with reference to the following drawings, where

FIGS. 1-3 are illustrations of problems with certain prior art solutions,

FIG. 4 is an illustration how the invention can solve the prior art problems,

FIG. 5 is a diagram of a high-level architecture of a preferred implementation of the system according to the invention,

FIG. 6 is an example of a data service management procedure,

FIG. 7 is a diagram showing an exemplary data service operation,

FIG. 8 illustrates possible locations of a data service functionality in a 5G/4G C-V2X architecture,

FIG. 9 illustrates a data service as a part of a 5G/4G C-V2X architecture,

FIG. 10 illustrates a further preferred implementation of the method and system according to the invention, which relates content-based message handling,

FIG. 11 illustrates map-matching for infrastructure messages,

FIG. 12 shows additional services related to a V2X application server,

FIGS. 13-14 show how message routing according to the invention can be implemented on a HD map and on an SD map, respectively,

FIG. 15 shows a preferred embodiment of a routing algorithm, and

FIG. 16 depicts an exemplary multi-domain implementation of message router instance handling.

### MODES FOR CARRYING OUT THE INVENTION

The invention relates to Cooperative Intelligent Transportation Systems (C-ITS) also known as V2X, and the invention is not bound to any specific radio and protocol implementation of a V2X system.

The invention allows ITS stations' (e.g., vehicles, TMCs, RSUs, etc.) relevant subsystem (i.e. ADAS or V2X) to subscribe to a tailor-made data stream service, which makes sure that only relevant information is delivered to receiving entities (e.g., vehicles), wherein relevance is based on preferences, location or other relevant data of the receiving entity. The solution also enables the publication of the V2X messages. The system according to the invention preferably has a decision logic that routes information or messages to receiving entities based on insights generated from map-matched position information of a target ITS station and other neighbouring vehicles and objects (including traffic light events, road information, etc.). The invention also relates to a routing method, as well as providing matching techniques of V2X-related entities, the connection and handling of application servers, and related scaling solutions.

The invention provides a solution for subscribed vehicles (i.e., vehicles connected to a message routing centre) to receive only relevant and appropriate type of infrastructure and V2X messages for better utilization of available resources.

In vehicles and other traffic participants information about a surrounding road topology and geometry fundamentally enhances the location and situation awareness. It immediately improves the quality of decisions and the efficiency of filtering. Map-matching vehicles and events or any other object with geographical relevance, greatly increases the accuracy and effectiveness of the applications and besides others supports movement prediction of an ego vehicle and all traffic participants.

Map-matching algorithms use inputs generated from positioning technologies (such as GPS or GPS integrated with DR) and supplement this with data from an accurate road network map to find an object's travel route.

The most common way to describe complex road networks is by using graphs. Each road is represented by an edge or multiple edges or leaves divided by vertexes to achieve better granularity, and to achieve more accurate results. Intersections are also represented by vertices where more than two edges are connected.

The general purpose of a map-matching algorithm is to identify a correct map object (edge) on which the vehicle is travelling and to determine the vehicle's location on that edge. Map-matching helps assigning vehicles and objects to either atomic road element, or—if the accuracy is sufficient—even to individual lanes.

Map-matching is a prerequisite of various location-based applications, such as navigation or vehicle tracking.

There are several solutions for solving a map-matching problem. For this invention any of the known map-matching methods and algorithms can be used that can provide map-matched location as a result.

A road segment is a group of connected edges and vertices around an edge to which the affected vehicle is mapped, including the edge itself.

Relevant edges and vertexes around a particular edge can be determined in real-time by special algorithms or predefined and stored in non-volatile memory.

Multi-access Mobile Edge Computing (MEC) is a technique that greatly reduces latency while also providing QoS (Quality of Service) guarantees in mobile networks. This concept locates an application function physically close to a user via a so-called local breakout. This mechanism prevents a packet from traveling through the whole network of the MNO (Mobile Network Operator); thus, the latency and QoS guarantees become manageable. Network slicing is a related technique that assigns network resources to various applications so that they can work with dedicated resource slices. A message routing functionality may (but not necessarily) be connected to both methods, i.e., MEC and network slicing. A natural deployment location for the message routing is the MEC, since a typical V2X use case requires low latency which can be typically achieved via deploying the service to the MEC. Network slicing is a key component to providing QoS. Since the message routing can handle various user preferences and data as well (while having a semantic understanding of the data), it can also provide resource estimations and predictions which are useful inputs for network slicing.

V2X application servers offer services for the V2X users. These applications are usually location-aware; thus, their functionality can either depend on or cooperate with the routing mechanism.

V2X applications have a potentially huge number of users, which can raise scaling concerns. The routing functionality itself shall be scalable, and in the scope of the scaling, it can also orchestrate the scaling of various V2X applications. Scaling can include instantiation, movements of running application instances, and a removal of instances.

The majority of ITS stations using the routing feature are expected to be highly mobile (vehicles for example). This means that a message router (also called router or message routing centre throughout the description and in the drawings) can decide to move user sessions and application states through installations, which process is called roaming.

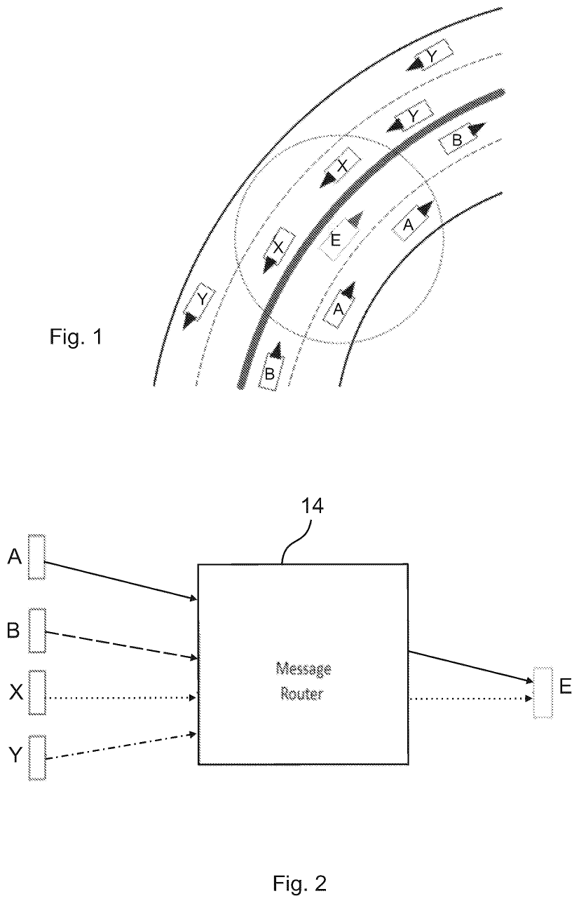

In C-V2X Uu communication there is a need for an infrastructure-side functionality to deliver C-ITS messages from senders (sources, source entities) to receivers (recipients, receiving entities). The routing of messages is not a trivial problem. The router needs to have at least basic location information about its registered client vehicles, i.e., vehicles that are connected to the router, e.g., via a subscription. When an incoming message is received the router must decide which other clients should receive this message or the content of this message, that is a traffic-related information. In prior art solutions and in the context of C-ITS, if a vehicle sends a message all surrounding vehicles should receive it, like in the case of a direct communication scheme. However, in the case of direct communication, the limited range of radio signals also limits the number of receivers, as only those vehicles can receive the message, which are in the range of the sender (e.g., similar to the scenario that is depicted in FIG. 1). In the case of C-V2X Uu, the message router should emulate this behaviour, by selecting the clients that should receive a message. If any type of distance-based relevance area (basically any arbitrary shape on a plain, typically a circle with a certain radius, an oval, or a rectangle around the sending vehicle) is defined, all vehicles will receive the messages that are in this area (see, for example in FIGS. 1 and 3). However, there are many traffic situations when pure distance is not a good indicator of whether a message should be received by a vehicle or not. This type of operation can reduce efficiency and unnecessarily reserve resources (such as bandwidth).

Another problem in current C-ITS systems is that vehicles cannot control which type of information they receive. A vehicle might not be interested in certain types of information while others need it. As an example, vehicles with different levels of autonomous driving capabilities might require different types of information. Or a vehicle driving in a platoon and another one that is about to join or leave a platoon might require different types of information than vehicles driving individually. Current C-ITS systems do not give means to vehicles to control the data stream they want to receive. Distribution of various message types can be use-case and relevance dependent as well.

The number of ITS stations (e.g. vehicles) using the routing service can vary greatly over time, therefore the spatial scope of the service can also be huge. The high number of users and their geographical distribution require scaling mechanisms to handle the requests in proper quality, which can also be handled by the method according to the invention.

The ITS stations are usually highly mobile, and the scaling implies that multiple routing instances need to be deployed. The roaming of the users' subscriptions also should be done by the message router or a module connected to the message router, such as a data service session handler.

The invention focuses on a part of vehicular communication that is not based on direct links between C-ITS entities (i.e., not DSRC (Dedicated short-range communications), or C-V2X PC5), but which is using infrastructure functions to route messages of vehicles (or other ITS stations) among each other. However, if necessary, direct communication can also be used. Currently, this type of communication is referred to using its most widely used implementation: C-V2X Uu. In this type of C-ITS communication vehicles are sending their messages to an infrastructure-based (hosted e.g., on an edge or cloud server) message router (a.k.a. broker) using preferably unicast cellular radio links (i.e., not broadcasting, like in the case of direct communication method) and receiving data on similar unicast cellular links. Other ITS stations, like a central ITS station, may also distribute messages via the message router. Like in the case of direct, broadcasting-based communication, the sender of a message does not know who will or shall receive its messages. While in the case of broadcast-based communication, all receivers within range have a chance to receive the broadcasted messages, in unicast-based communication there can only be a single receiver. In a typical traffic situation, there are multiple vehicles that should receive a message sent by a certain vehicle. Thus, unicast-based communication needs an infrastructure-based function or module that connects message senders and receivers. Each vehicle that intends to send messages can send the messages to said infrastructure-based function. Each vehicle that intends to receive messages can subscribes to the infrastructure-based function, which will send them the received messages. The message exchange is not limited to vehicles, other ITS stations may also send or receive messages.

The invention relates to a decision logic of the infrastructure-based message routing function which can decide which incoming messages should be delivered to which subscribed clients (e.g. vehicles). The invention can also handle non-vehicular information and the scaling of the function together with the related services.

The above-described mode of communication can be used parallel with direct communication. Furthermore, receivers and senders can decide which type of information is sent on direct/broadcasting links and which type on the infrastructure aided message delivery scheme. They can even decide to send/receive a message on both schemes in parallel.

The system according to the invention preferably comprises a subscription and data service management module (e.g., a data service session handler) that enables vehicles to select the type of information they intend to receive along with other preferences.

The system according to the invention further comprises as a core element a map-matching-based message routing centre (a map-matching-based message routing function or functionality) that can select the relevant messages to subscribed (connected) entities and delivers only such information.

The subscription and data service management module and the map-matching-based message routing centre together provide means for vehicles to subscribe to a tailor-made data stream service indicating which type of messages they want to receive along with other preferences detailed below. Preferences might include (but are not limited to) their safety, security compliance, performance capabilities, the applications they are interested in, or range-based information (e.g., how much the vehicle intends to see ahead). This works in tandem with an infrastructure-side message routing functionality (i.e., the map-matching-based message routing centre) that selects the sources that are relevant for the subscribed clients and only delivers the relevant messages to the subscribers. Relevance can be calculated based on, but not limited to, preference, message type, the content of the message, and the location (and related kinematic data) of the message concerning the subscriber vehicle's state. This way vehicles do not have to select relevant messages on their own, but the infrastructure performs the selection based on their preference. A vehicle only defines the type of data it intends to receive but does not define from which sources exactly.

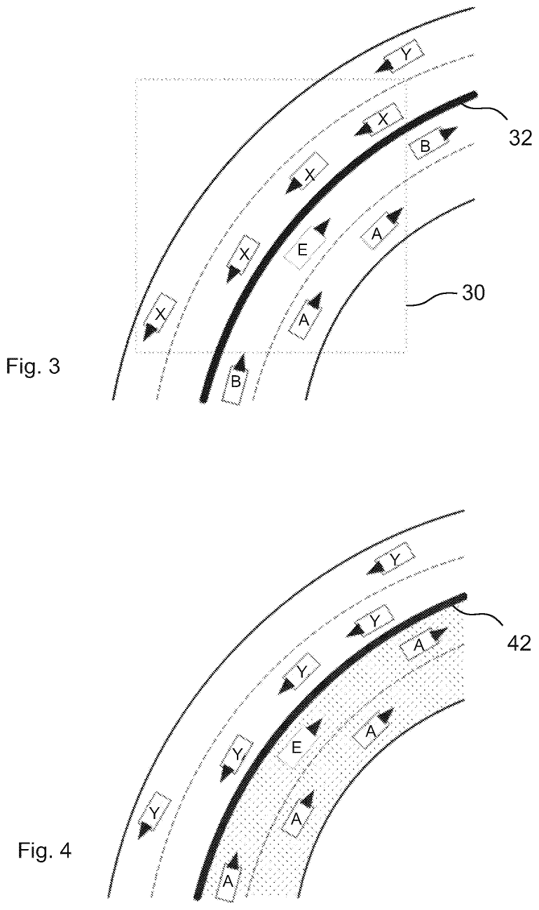

In FIG. 4, a possible definition of a map matching-based relevance is given, which solves the two types of problems described in connection with FIG. 1. According to the example of FIG. 4, the vehicle marked “E” (ego vehicle) is map-matched first, which means that its location is matched with a route segment on which it drives. In the example, it is a side of a highway marked by a dotted pattern, wherein the highway has a barrier 42 dividing lanes leading to opposite directions. Similarly, all other vehicles (denoted by “A” and “Y”) are matched with their respective correct route segments. The message routing centre preferably applies a filter to the incoming messages and selects only those that are coming from vehicles on the same road segment as the vehicle marked “E”, i.e., the vehicles marked “A”. Only these messages are transmitted to the vehicle marked “E”. As the vehicles marked “Y” are not driving on the same route segment as the vehicle marked “E” the filter won't select messages coming from them to be transmitted to the vehicle marked “E”.

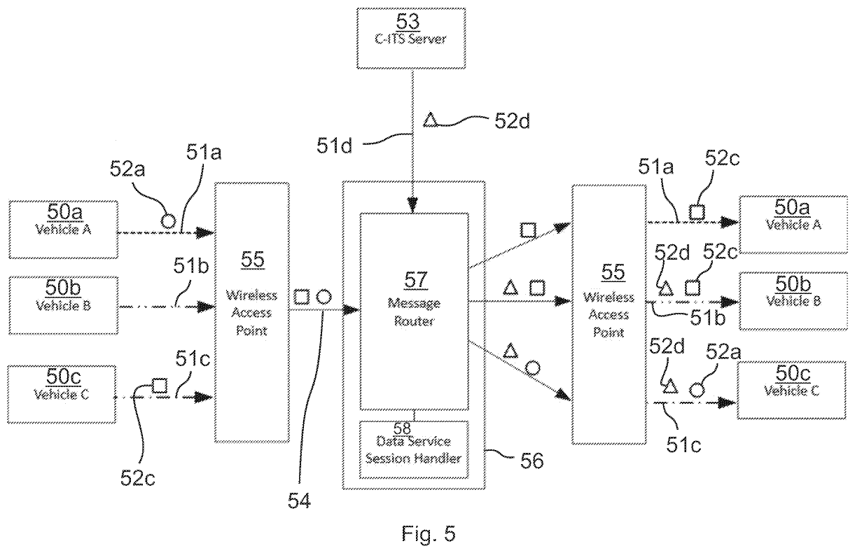

In FIG. 5 a conceptual high-level architecture of the system according to the invention is shown. In this example vehicles 50a, 50b, 50c (vehicle A, B, and C) are all already subscribed to the service (e.g., via a data service session handler 58), and they are already sending and receiving messages. In this example, vehicles A, B and C are sending their C-ITS messages to a message router 57 (i.e., a message routing centre). Preferably, the message router 57 and the data service session handler 58 are in a communication connection, thereby the data service session handler 58 can provide the message router 57 information, e.g., preferences of the vehicles A, B and C. Preferably, the message router 57 and/or the data service session handler 58 is hosted e.g., on an edge (such as MEC) or cloud server 56. In this example, vehicles A, B and C are using unicast radio links 51a, 51b, 51c, respectively to transmit their messages to the message router 57.

According to the depicted example, vehicle A transmits information 52a via unicast radio link 51a, while vehicle C transmits information 52c via unicast radio link 51c. Furthermore, there is a C-ITS server 53 which can also send messages via a link 51d to the message router 57, the message containing information 52d.

The message router 57 sends the C-ITS message of vehicle C containing information 52c via unicast radio links 51a to vehicle A as vehicle A intends to receive those types of messages and vehicle C is in the relevance area of vehicle A in accordance with its preferences. Vehicle B is receiving the C-ITS message containing information 52d of the C-ITS service as vehicle B is subscribed to those types of messages, and those messages are relevant to vehicle B according to its state and its preferences. Vehicle B is also receiving the C-ITS message of Vehicle C containing information 52c as this is relevant for vehicle B and vehicle B is subscribed to those types of messages, too. Finally, vehicle C receives the C-ITS message of the C-ITS server containing information 52d and message of vehicle A containing information 52a along the same logic as described above.

In summary, in FIG. 5, each client of the message router 57 only receive that is deemed relevant for them based on map-matched location data and their preferences.

The system according to the invention may also include one or more wireless access points 55 arranged between the source entities (vehicles A, B, and C and/or C-ITS server 53).

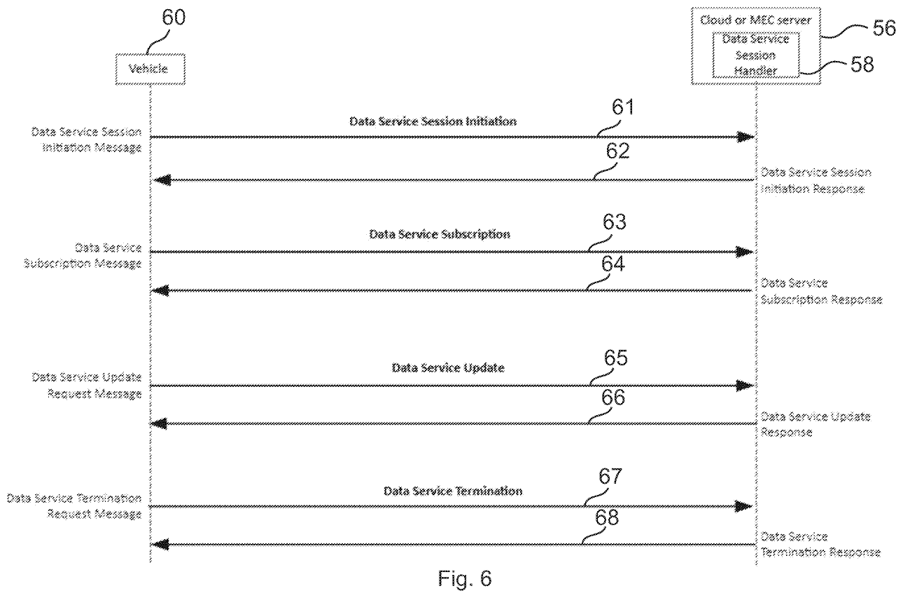

FIG. 6 shows possible ways of interaction between a vehicle 60 and a data service session handler 58, preferably being operated in a cloud or a MEC server 56.

Each vehicle 60 that intends to use a tailor-made (user-tailored) data service should first subscribe to the service. The implementation of the subscription mechanism is typically a multi-message exchange protocol. For the message exchange any message formats and protocols known in the art can be used. In other embodiments more or less messages can be used than depicted in FIG. 6.

The message service subscription and management protocol preferably includes at least 4 message exchange procedures, which are described in the following in more detail.

### 1. Data Service Session Initiation Procedure

This procedure is used by an initiator (typically a client, e.g., a vehicle 60) to initiate data service session with the server 56 by sending a Data Service Session Initiation Message 61. In case the server 56 can accept the request, it allocates the necessary resources to handle the vehicle data service session. These include the following functional entities:
a dedicated data service session,
a server-side receiver module to receive messages from the registering vehicle 60 (e.g., SA),
a filtering module that will handle the map-aware filters defined by the registering vehicle 60 (e.g., FA),
a preference handler module that will handle the message/information type-related preferences of the registering vehicle 60 (e.g., PA),
a message router entity dedicated to the registering vehicle 60 that is responsible for handling subscriptions to relevant messages/information sources based on the actual input from the filtering and the preferences module (e.g., MRA).

Finally, the server responds with a Data Service Session Initiation Response 62 notifying the vehicle 60 about the success or failure of the registration.

### 2. Data Service Subscription Procedure

This procedure is used by an initiator (typically a client vehicle 60) to communicate its preferences about what type of messages/information it intends to receive from the data service as well as the corresponding relevance area filters and priorities. The relevance area is not limited to a single geographic area, as it can also be a plurality of road segments that the vehicle 60 is going to follow. The filtering requirements and the preferences of the registering vehicle 60 are loaded into the filtering and preferences modules, respectively, dedicated to the registering vehicle 60. As shown in FIG. 6, in this step the vehicle sends a Data Service Subscription Message 63 to the data service session handler 58, and the data service session handler 58 provides the vehicle 60 with a Data Service Subscription Response 64.

### 3. Data Service Update Procedure

This procedure is used to update a parameter of the data service session of the initiator, e.g., a vehicle 60. The primary purpose of the procedure is to enable vehicles 60 to update their preferences regarding message/information type receptions as well as update filter preferences. The initiator of the procedure (typically a client vehicle) sends a Data Service Update Request Message 65 to the data service session handler 58. In the Data Service Update Request Message 65, the sender indicates its new preferences. The data service session handler 58 updates the session accordingly and responds with a Data Service Update Response 66. The update of the session parameters might or might not be successful. The result is indicated in the Data Service Update Response 66.

### 4. Data Service Termination Procedure

This procedure is used to terminate the data session service between a vehicle 60 and a data service provider. The procedure has a Data Service Termination Request Message 67 and a Data Service Termination Response 68. The procedure is typically initiated by a vehicle 60 (data service client), but in general, it can be initiated by either endpoint, e.g., even by the data service session handler 58. The initiator (the vehicle 60 in the example) sends the Data Service Termination Request Message 67 to the responder (the data service session handler 58 in the example). The responder terminates and clears up all service entities related to the initiator and sends a Data Service Termination Response 68, which acknowledges the termination. Sending the Data Service Termination Response 68 is optional. The initiator terminates and clears up all session-related entities either on the reception of the Data Service Termination Response 68 or after an implementation-dependent timeout.

After the data service session setup each subscribed vehicle 60 preferably continues to update its location and other relevant state information at the server 56 during the lifetime of the session. In one implementation this is achieved by vehicles 60 sending their CAM (according to EU standards) or BSM (according to US standards) messages to the server 56. These types of messages contain the actual GNSS-derived location of the sender along with other static and dynamic parameters of the vehicle 60. The server 56 can use this information to map-match each subscribed vehicle 60. This means that the server 56 can compute and continuously update the road segment on which the vehicles 60 are driving. These are preferably stored in a database hosted by the server 56. Another approach can be where the vehicles 60 perform map-matching on themselves and share the result of the map-matching with the server 56 via a suitable message.

Generally, besides the continuous location update there are no mandatory messages or information that need to be published by the client vehicles 60, i.e., a client vehicle 60 can use the service in only reception mode, but on a wider scale this is implementation specific. Furthermore, other traffic participants such as RSUs can also subscribe for the services.

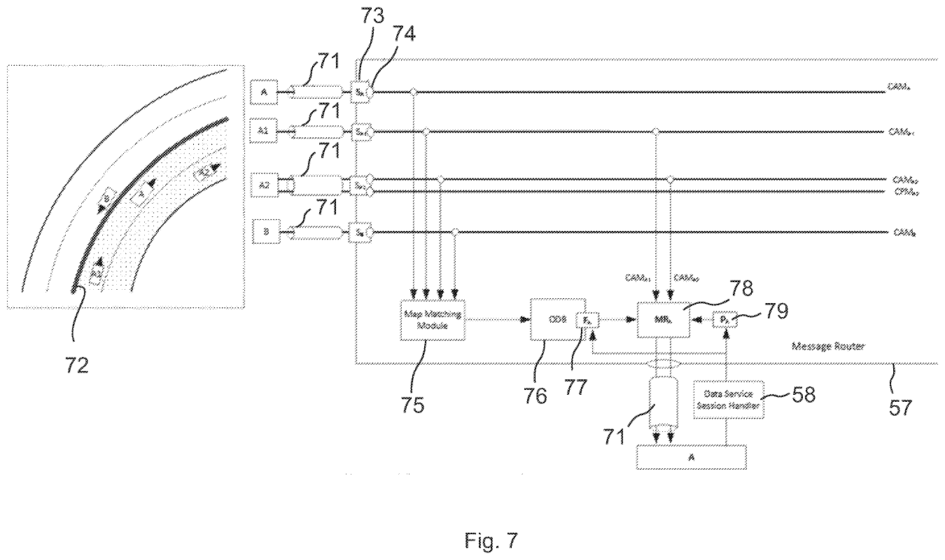

In FIG. 7 an exemplary operation of the data service is shown. The assumed traffic situation is shown on the left side of the figure. Similar to FIG. 4, FIG. 7 also relates to a highway, wherein vehicles are moving in both directions and the opposite lanes are divided by a barrier 72. On one side of the highway there are three vehicles (A, A1 and A2), and on the other side there is another vehicle (B). The situation is explained from vehicle A's point of view.

According to the example, all vehicles (A, A1, A2, B) have performed the Data Session Service Initiation and Subscription procedures and are continuously updating their locations with the data service session handler 58 hosted on the server. In this example, the location update is achieved by each subscribed vehicle sending its CAMs to the server.

Each vehicle may use one or multiple unicast radio channels 71 to communicate with the server in both directions (downlink/receiving messages and uplink/sending messages).

The operation of the data service is as follows in the above explained scenario. Vehicle A is used as an example client. Vehicle A and all other example vehicles are sending their V2X messages to the dedicated server-side receiver module 73 (also denoted by SA, SA1, SA2, SB, respectively) created during session initiation. In the example, all vehicles are sending CAM messages and vehicle A2 also sending CPM messages. The server-side receiver modules 73 handle dedicated internal publish topics 74 for the corresponding vehicle per message type. Consequently, all vehicles server-side receiver modules 73 have CAM (CAMA, CAMA1, CAMA2, CAMB for each vehicle, respectively) topics 74 where they publish the corresponding message types, i.e., CAMs from the associated vehicles. SA2, i.e., the receiver module 73 associated with vehicle A2 also opens a CMPA2 topic 74, as vehicle A2 transmits CPMs besides CAMs.

Internal modules (as will be discussed later) in the server can subscribe to the published topics 74 according to their message type and filter references.

One particular internal module is a map-matching module 75, which subscribes to all CAM topics 74 to receive location information from vehicles, as CAMs contain location data of the sending vehicle. The map-matching module 75 preferably uses received CAMs to map-match all registered vehicles and continuously updates the matching as new location information is received from a particular vehicle. The results are stored and updated in an object database (ODB) 76. Alternatively, the location information may be obtained from elsewhere, for example from the exposed network functionalities in the case of 5G connectivity.

In the case of a registered vehicle, a dedicated message router module 78 (MRA for vehicle A) subscribes to internal topics 74 according to the vehicle's preferences 79 (PA for vehicle A) and the actual input from a map-aware filter 77 (FA for vehicle A). In the case of vehicle A, at the point in time that is used in the example, the MRA module 78 subscribes to CAMA1 and CAMA2 topics 74. On one hand, the FA module 77 tells the MRA module 78 that at the moment there are two other vehicles in the relevance zone of vehicle A: vehicle A1 and vehicle A2 as they are driving on the same side of the highway. On the other hand, the PA module 79 tells the MRA module 78 that vehicle A is only interested in CAM messages. Thus, MRA module 78 subscribes to the CAM topics 74 of vehicle A1 and vehicle A2: CAMA1 and CAMA2, respectively. This is not a static subscription setup. On one hand, new vehicles can enter or exit the relevance zone of vehicle A, in which case MRA module 78 will receive updated input from FA module 77 and subscribe or unsubscribe from topics 74, respectively. On the other hand, vehicle A may change its filtering and/or message type preferences using the Data Service Update procedure described above.

The message router module 78 (MRA for vehicle A) transmits the messages received on the subscribed topics 74 to the registered vehicle on a dedicated unicast radio channel or channels 71.

Similar processes and modules are in action in the case of other registered vehicles, too. Each of them might have different preferences for message types and relevance area filters. Consequently, each vehicle receives a tailor-made, unique data stream from the server, i.e., from a message router 57.

There might also be non-vehicle type registrations, e.g., a C-ITS server of a road operator, or vehicle manufacturer might also register to the data service either to collect data about the traffic or about certain vehicle models as well as to send various types of messages to vehicles traveling in relevant locations.

The map-matching module 75, message routing module 78, object database 76, and data service session handler 58 may run on one or multiple physical machines. These modules, elements can be deployed on public or private edge or central cloud servers.

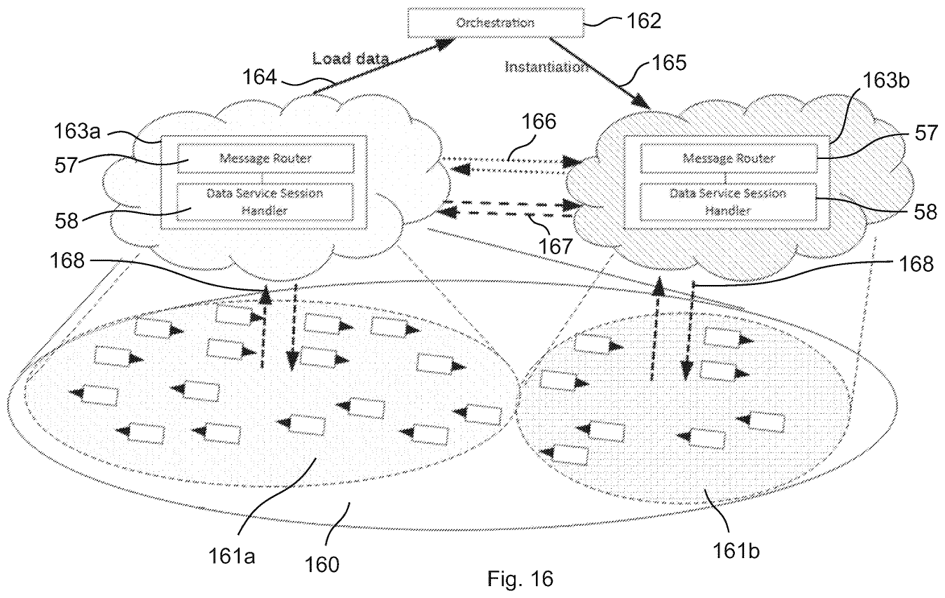

More than one instance can be active of all the above functional modules, e.g., multiple message routing 78 instances on different edge servers. These instances may divide the whole service area of the service into smaller geographical areas (see FIG. 16). The division can be static or can be dynamically changed based on changing load in individual areas. A load balancer functionality might be used to distribute traffic between worker instances keeping an equal computation load on each instance. The number of active instances can also change in time: at high-demand times more instances might be activated, while at low-demand hours some instances might be terminated.

Map-matching information can come from any source, e.g., vehicles that are capable of map-matching themselves or other traffic participants can also share these map-matched results.

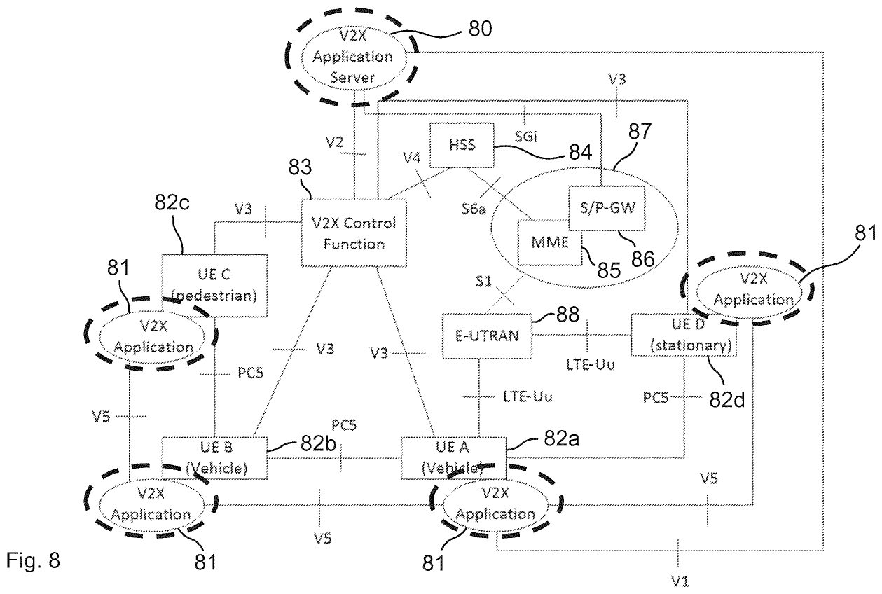

The message router and all described functional elements can be implemented to run in a V2X Application Server 80, an example of which is shown in FIG. 8.

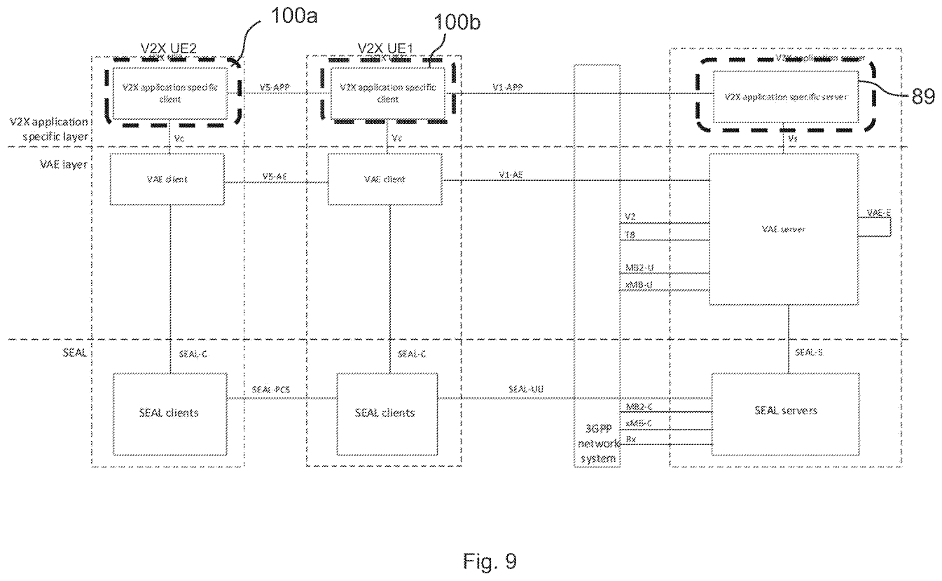

The server-side functions can be implemented/deployed as part of one or more V2X Application servers, while the client-side function as a V2X Application as shown in FIGS. 8 and 9.

FIG. 8 shows a possible integration of the data service functionality of the method according to the invention into a 5G/4G C-V2X architecture as described in the 3GPP ETSI standard (3GPP TS 23.285 (https://www.etsi.org/deliver/etsits/123200123299/123285/16.04.0060/ts123285v160400p.pdf; see page 9, FIG. 4.2.1.1-1).

FIG. 8 shows how the client and server-side components mentioned can be deployed in a cellular environment.

The message routing centre can be implemented as a part of the V2X Application Server 80, which in the 3GPP terminology handles V2X message routing between different UEs 82a,82b,82c,82d (e.g., cars).

V2X Applications 81 generate the messages and can also subscribe to/receive other messages forwarded by the V2X application server 80.

V2X Control Function 83 is part of the 3GPP network and is the logical function that is used for network related actions required for V2X as in 3GPP TS 23.285. V2X Control Function 83 is used to provision a UE 82a,82b,82c,82d with necessary parameters in order to use V2X communication.

Further components shown in the figures are the following, wherein the abbreviations are defined in ETSI standard 3GPP TR 21.905 (see for example: https://www.etsi.org/deliver/etsitr/121900121999/121905/16.01.0060/tr121905v160100p.pdf): HSS (Home Subscriber Server) 84—central database containing the user-related information/profiles and performing authentication and authorization tasks within the cellular network

UE (User Equipment) 82a,82b,82c,82d—an end device using the cellular network. For example, a car, a pedestrian, or any other device that can connect via cellular networking and transfer V2X messages.

MME (Mobility Management Entity) 85—a control node within the cellular network with a key role in managing UE mobility.

S/P-GW (S-GW: Serving Gateway, P-GW: Packet Data Network Gateway) 86—S-GW routes and forwards data packets, P-GW: provides connectivity for the UE to external packet data networks.

E-UTRAN (Evolved UMTS Terrestrial Radio Access Network) 88—air interface in an LTE cellular network.

FIG. 9 show that the functionality of the message routing centre and the client-side application (i.e., V2X message transmission/reception) can be a part of the “V2X application specific layer” in the 3GPP terminology, i.e., a 4G/5G C-V2X architecture.

FIG. 9 is based on a functional model from ETSI standard 3GPP TS 23.286 (https://www.etsi.org/deliver/etsits/123200123299/123286/16.06.0060/ts123286v160600p.pdf, see page 14, FIG. 6.2-2).

V2X application specific server 89 performs the functionality of the V2X Application Server 80 (see FIG. 8) that is specific to the V2X service and not to control plane interactions with the 3GPP network. For example, this may include the message routing centre and its functionality, or map-matching algorithm, or any V2X-specific algorithms, but exclude network/cell discovery or authentication with the 3GPP network, etc.

V2X application specific client 100a, 100b performs the functionality of the V2X application 81 (see FIG. 8) that is specific to the V2X service not related to control plane interactions with the 3GPP network. For example, this may include the generation and transmission of a specific V2X message, but exclude cell/discovery or authentication with the 3GPP network, etc.

FIGS. 8 and 9 gives an example of how (and where) the invention can be implemented in an existing system/ecosystem, which in this case is the 3GPP cellular network.

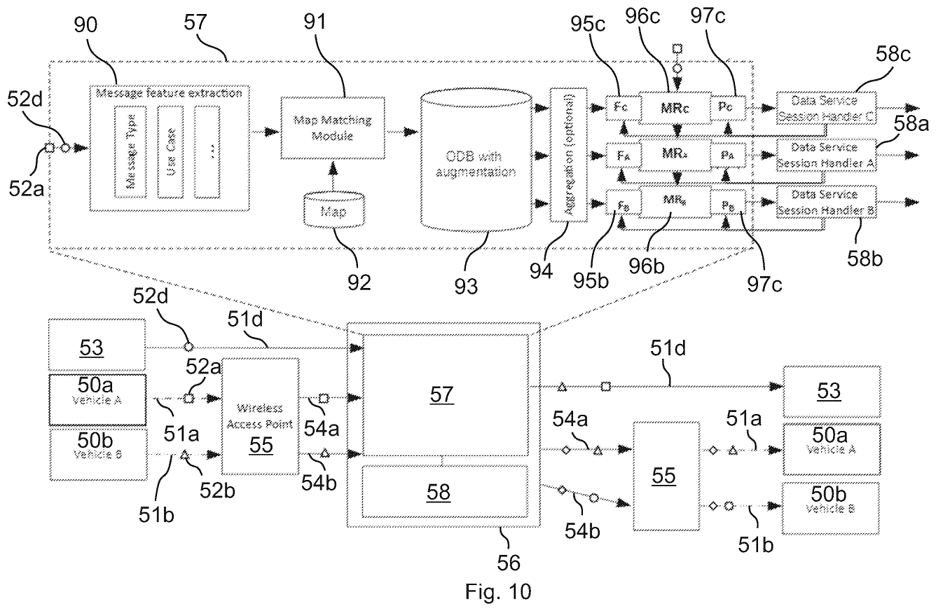

FIG. 10 illustrates a further preferred implementation of the method and system according to the invention, which relates content-based message handling. FIG. 10 provides more detail of the internal structure and processes of the message routing centre 57 already shown in FIG. 5. For conciseness, only the features not yet shown in FIG. 5 are discussed in more detail.

In IT systems, routing decisions are usually made based on network layer addresses. In most cases, some kind of routing tables are populated in each router, and for all individual packets, the next hop is determined based on the aforementioned table. In contrary to this, the method and system according to the invention makes routing decisions based on relevance calculation. The main steps of the calculation are the following. 1. Message feature extraction module 90. First, a packet is labelled with various properties. Labels can include (but are not limited to) the type of the message (CAM, DENM, etc.), the related use cases, etc.

2. Map-matching module 91. In this module, each message is associated with one or more identifiers related to the road topology, such as a link ID. The map-matching method (the used data fields for example) is preferably specific to the used message type. The map-matching module 91 is connected to a map 92 to retrieve map data.

3. Object database 93 with augmentation. The map-matched objects from the map-matching module 91 are fed into an object database 93, which contains an abstract representation of the objects encoded in the messages. The messages themselves can also be stored along with the representation. The object database 93 is not necessarily persistent, it can be as simple as a multiplexer for the client-specific routing modules, but if the subscription modules require, it can also store a history of the messages.

4. Aggregation module 94 (optional). In V2X messages, a simple object can be represented by multiple messages simultaneously. For example, a vehicle can be represented via sending CAMs from themselves and also via CPMs which encode the sensory detection of the infrastructure or the surrounding vehicles. This data can be aggregated and sent via a joint CPM. With the aggregation module 94, the frequency of the messages can also be limited. For example, if a client is only interested in CAMs with a limited frequency (e.g. it only collects statistics), then the aggregation module 94 can aid the filtering of the messages for the client. The aggregation module 94 can also ensure that DENMs are not repeated unnecessarily; thus, only changed/updated messages are forwarded (DENMs are regularly repeated without change in the content).

5. Routing. A routing decision is calculated for each client via a routing module 96a, 96b, 96c. Each client has a data service session handler module 58a, 58b, 58c, which provides parameters for its respective filtering module 95a, 95b, 95c and preferences 97a, 97b, 97c of the routing module 96a, 96b, 96c. Such parameters can be a message type, a use-case (for example DENM use cases), etc. The routing module 96a,96b,96c calculates the relevance to the receiver client using its preferences 97a, 97b, 97c. There are two options to implement the actual routing mechanism. In the first option, all packets flow through the pipeline and the decision is made at the end of the pipeline. In the second option, a routing table is filled. In contrast to a regular routing table, the decision is made based on the source of the information instead of a destination address. In the case of CAMs, for example, the source ID can be the Station ID. In the case of DENMs, the source ID can be the Source ID can be the ActionID.

During the implementation of the routing, various optimizations are applicable. Some examples are the following.
The map-matching module 91 can use historical matching data to increase efficiency.
The clients can include metadata in their message structure to save resources during the routing mechanism. For example, the CAM station ID can be encoded into the topic name, where the message is published (assuming a publish-subscribe model with topics). The ActionID of the DENMs can also be encoded similarly.
Approximate location information can be added as metadata for more efficient routing and aiding scalability.

Performing map-matching on various messages are not trivial in all cases.

As an example, there are messages, which are used to share status information of the source entities. (Such are CAMs, BSMs, Maneuver Coordination messages, PSMs and VAMs, platooning messages.) The map-matching is straightforward in these cases, because the source entities are typically driving on a road; thus, their position needs to be map-matched.

As a second example, in the case of perception-sharing messages (such as CPMs or SDSMs), the detected entities might be on different road sections. Here, two different approaches can be taken. In the first approach, a message relevant for each road section can be marked which can be in the field of view of our sensor. In the second approach, an aggregation feature can be utilised. Here, all the detected objects are map-match and new perception messages are created for all links. Then, the subscribers will only be notified about the relevant objects. With this approach, the perception messages can be split into relevant parts.

As a further example, in the V2X domain road status messages can also be shared. These messages can be classified based on how they describe the road events. Some messages, like RSA, describe an event as a single position. It is straightforward to map-match these kinds of messages. There are other messages, like IVIMs, DENMs, or TIMs, which can describe paths. (Either the event itself can be interpreted along a path, like a speed limit, or an awareness zone of the event is path-shaped). In both cases, the path itself needs to be map-matched. This method can be performed via simulating a vehicle moving on the defined paths and recording the matched road sections. In these cases, the message will be relevant in all touched road segments.

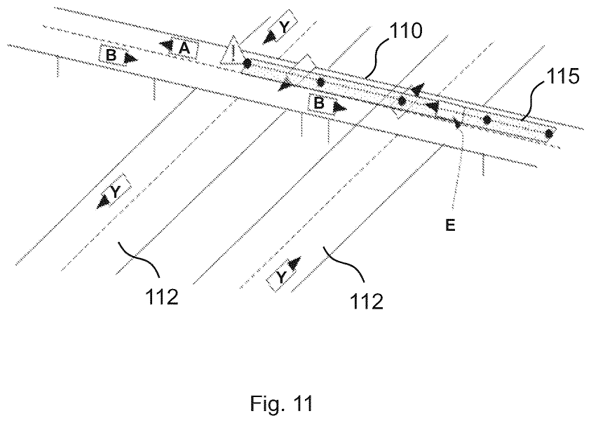

FIG. 11 illustrates map-matching for such infrastructure messages. In FIG. 11, the DENM indicating a road hazard is depicted with a warning triangle. The trace (path) leading to the event is marked with a dotted line, and it corresponds an affected area 115. The map-matching method in this example will only send the warning message to the vehicle marked with “E”, whereas a plainly geographical approach would send the message to all vehicles in the figure, i.e., including the vehicles denoted by “B” that are moving in a different direction near the affected area and the vehicles denoted by ‘Y’ that are moving on a road 112 not intersecting with the affected area located on a bridge 110. A method that inspects the DENMs and sends messages to all vehicles in the traces could briefly send the messages to the vehicles marked with “B” as well as a precaution.

As a further example of non-trivial map-matching subjects, V2X communication can also cover intersection-related messages. Such messages are a MAP, SPAT, MAPEM, SPATEM, SSM, SRM, SSEM, SREM. In these cases, the map-matching needs to identify the related intersection description message (the MAP/MAPEM) and match its ingress lanes with the map of the routing solution. The method can be similar to the one described in the road status message part. Then, each message related to that particular intersection will be relevant for the matched paths.

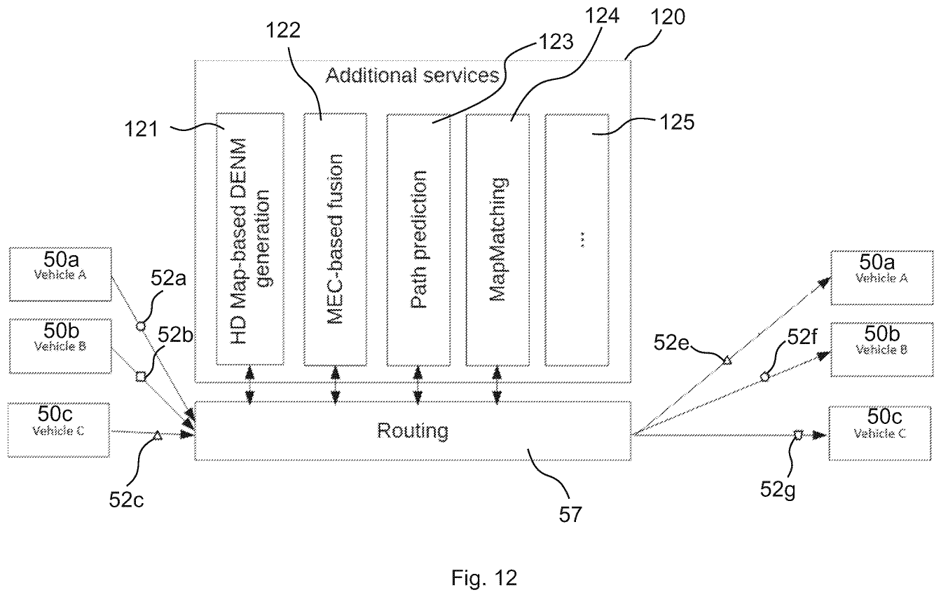

FIG. 12 shows additional services 120 related to a V2X application server that can help message routing in the method and system according to the invention.

The map matching-based routing method can interface with other services, which help a V2X subsystem of the receiver entities to reduce computation needs or create more efficient applications. Such applications might include, but are not limited to the following.
A MEC-based fusion module 122 can collect relevant entities for a subscriber on the server side and sends an aggregated data to the subscriber. This MEC-based fusion module 122 first collects the data regarding each entity. Then, it identifies redundant data sources, for example, third-party perception data (SDSM, CPM) and status information of the same entity (BSM, CAM, etc.). After that, it can combine the data, which results in improved data quality thanks to the combination of different independent sources. Eventually, the MEC-based fusion module 122 identifies the relevant data for the subscriber and assembles the message containing a consolidated data. If necessary, the MEC-based fusion module 122 might also ensure the integrity and source of the message via proper cryptographical methods.
A path prediction module 123 can share a predicted future path of moving entities. Based on a deep understanding of a road network topology, possible redundant data, and statistical data of vehicles driving along a road segment, the path prediction module 123 can predict the future movement of connected and unconnected entities. To calculate the predicted path, machine learning and classical methods can also be used as known in the art. The path prediction module 123 can append path information to perception messages or status messages as well. It can also be used along with the MEC-based fusion module 122.
A map-matching module 124 can append map-matching information along with an actual message. A subscriber can use this information to enhance the efficiency of its applications. The usage of the map-matching data requires a common understanding of the road topology in the map-matching module 124 and in the subscriber.
A digital twin awareness module (not shown in FIG. 12) can send awareness notifications to a subscriber. This module mirrors the V2X safety applications on the server side. It subscribes to the relevant entities and processes them. Upon a dangerous situation, it sends an awareness notification to the subscriber.
As a further additional service module 125, the system and method according to the invention can also incorporate RSUs. This service uses the RSUs as gateways to improve the coverage. It can collect messages from RSUs to include direct communication messages in the system. This service also tags these messages with the proper metadata in order to aid the operation of the system. In cases where the cellular coverage is insufficient and the RSU coverage is available, then the messages can be distributed via the RSUs as well. The system tracks the available RSUs, and their coverage and decides upon the transmission channel (Uu of PC5) based on coverage (if PC5 via RSU or 5G Uu is available), network utilization (PC5 or Uu channel utilization), and client capability (e.g. available interfaces; preference) data. The coverage can be maintained based on statistics of received periodic messages (like BSMs) or other methods, like simple distance-based models as well.
A smart awareness message generation service module 121 (HD map-based DENM generation module) can detect road events based on analysis of other messages. For example, it can detect an accident based on CAM or BSM sequences. It can also detect slippery road conditions based on CAMs or BSMs. Then, it matches the events to the map, creates the paths toward the road event based on its knowledge about the road network topology, and sends this information to the subscribed clients.
A HD map improvement module listens to moving entity information (like CAM/BSM status messages or CPM/SDSM perception messages) and matches those entities to the road topology. Then, it computes the distance of the entities to the center of the lanes and if it finds a constant deviation from the map data, it can feed back correction data to the map provider. Based on clustering methods, it can also detect the number of lanes on the road segment and it can create feedback on that similarly.
A misbehaviour detection module (not shown in FIG. 12) can continuously analyse message sequences (e.g., streams) looking for potentially malicious users. For example, if the CAM sequence of a vehicle jumps kilometers in seconds, then the data coming from that vehicle is clearly not trustworthy. The service might use machine learning or classic algorithms to look for misbehaviours. Eventually, this module can flag the messages as untrusted so that the receivers or subscribers can ignore it.
A V2X transmission control module checks if a data source (data transmitters; either infrastructure or vehicular) is relevant for data targets (receivers; primarily vehicles). The relevance is calculated based on the preferences of the target shared with the message broker during the subscription and the physical properties of the target (position, speed, map matching result, etc.). Based on the calculated relevance, the module calculates the required transmission frequency of each particular message service on each data source. Then, it negotiates the required message-sending frequency with the data sources. As a result, the data sources adapt their message generation frequency to the required values. As an example, if a vehicle with CAM sending service drives along a road segment alone, then thanks to the V2X transmission control module, it can reduce its message-sending frequency to a relatively low value. With this action, it effectively reduces data usage without sacrificing the quality of other services. However, if multiple vehicles are around the target vehicle and they need data from it, then the service will instruct the data sources to generate a proper number of messages (e.g. 10 Hz).
A V2X reception control module can drop the least relevant data (while considering fairness and putting less relevant data occasionally into a data stream) for a client if the client communicates that it cannot perform more packets than a certain threshold. This solution ensures that a receiver will not be overloaded, while it will be updated with the most recent information.
An ODD (Operational Design Domain) module can monitor and manage service availability based on geographical information. For example, based on map-matched information of a vehicle and network availability information it may notify the vehicle if any of the preferred/requested/configured aspects of its registered ODD profile are violated. Additionally, it may provide further information to the V2X transmission control module which then initiates a Data Service Update procedure (see FIG. 6) on the server side to reconfigure/update the session with the UE. Combining the map-matched location information of the vehicle with other information of the network state, like QoS or slicing availability in 5G cellular networks, the ODD module can further improve the overall service experience of the vehicle by applying changes in the vehicle's configuration advance.
A V2X application server handles plenty of V2X messages. Based on the handled messages, it may detect various events. In case the V2X application server detects a road event, it can create new V2X messages (e.g., a DENM) to distribute the information about the event. The event detection can happen based on (semi-) automatized processes, or via an operator. Instead of describing a single position, the event descriptor messages usually contain data about the affected/preceding road segment. The V2X application server matches the event to a road segment and fills the affected/preceding road segment accordingly. Using this item, it is sufficient for the V2X application server to provide the location of the event.
A platoon orchestrator module can listen to the incoming messages from the publishers and look for candidates to form a platoon. The vehicles may have indicated their general interest in forming a platoon during the subscription procedure. If it successfully found vehicles which could team up for a platoon, then it can initiate or ask the subject vehicles to initiate the platooning. In case a platoon group forms, it registers itself to the platooning orchestration module, which starts the management tasks of the platoon (e.g., maintains the member list).
In an end-to-end security module, a V2X application server can apply its access control mechanisms and intelligent misbehaviour detection methods in order to filter out the malicious or misbehaving clients from the system. As a result, the V2X application server can guarantee the end-to-end security of the system.

As FIG. 12 depicts, with the help of one or more of the above-mentioned modules and services, the system and method according to the invention can provide its subscribers not only with forwarded relevant messages, but new messages can be created and sent out to subscribers including additional or more personalized information.

As an example, according to FIG. 12, vehicle 50a can receive an aggregated message 52e comprising a CAM from vehicle 50c with path prediction and map-matching result. Vehicle 50b can also receive a fused message 52f comprising fused data with perception messages. Vehicle 50c can also receive a composite message 52g comprising DENM with traces from the map.

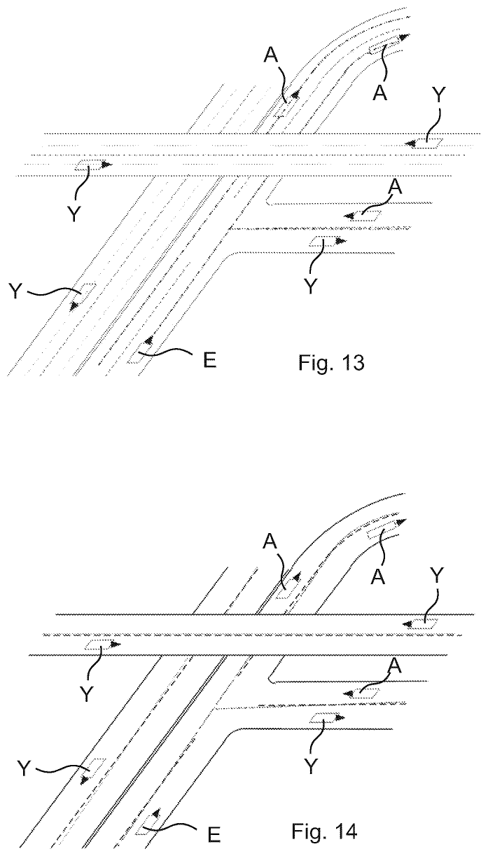

FIGS. 13 and 14 represents how message routing according to the invention can be implemented on a HD map and on an SD map, respectively. As a HD map comprises lane-level information, map-matching and message routing can rely on lane-level position information. An SD map comprises less details, however it also includes road topology, therefore the relevant vehicles (denoted by “A”) and the irrelevant vehicles (denoted by “Y”) from an ego-vehicle's (denoted by “E”) point of view can be properly separated.

In FIGS. 13 and 14 dotted and dotted-dashed lines are always in the centre of the road; the lines are only shifted to improve visibility in the illustration.

In the following, it is described how the V2X messages are routed to the vehicles according to the invention. In the 3GPP terms, such a functionality is implemented in a so-called V2X application server. There can be several approaches that solve the V2X-specific routing problem. Some of them are listed below.
A geohash-based forwarding method can divide the Earth into geographical regions (georegion). Each client calculates their own geohash, which identifies their current georegion. The clients tag their messages with the geohash so that the router can use that information for message distribution. Each client subscribes to messages regarding their own georegion (the one they are located in) and the router forwards the messages with the same tag for them. The geohashes can implement a hierarchical structure so that the size of the regions can be fine-tuned. An example implementation can be done in MQTT, where the geohash is encoded in the topics. The subscription then can be performed for those topics, even in a wildcard format. A key drawback of this solution is the roaming problem. If a client leaves a certain georegion and enters a new one, it will not receive messages from its close proximity until it updates its subscription to the new area.
An improved geohash-based forwarding can fix the most important drawback of the geohash-based forwarding. In this case, the clients subscribe to other relevant georegions as well, for example to their neighbouring regions. Thus, the roaming problem is solved by performing the subscription in advance. However, this method still suffers from the issues presented earlier, namely that a purely geographical approach can filter out relevant entities due to curvy roads for example; while it can also include irrelevant entities because of e.g. bridges. A possible implementation can be performed similarly to the geohash-based forwarding approach.
A per-vehicle relevance calculation method can calculate a relevance area of each individual message and all receiver within that region will receive that message. For example, in the case of GeoNet network layer, the relevance area of the GeoBroadcast header can be used for the calculation. In the case of SingleHopBroadcast, the relevance area is a circle where the center of the circle is a source position vector in the GeoNet header, whereas a radius is a technology-dependent constant (In this case, it is likely 500 m or 1000 m). In contrast to the improved geohash-based forwarding, this method will provide a more balanced message distribution, i.e., the receivers will receive messages from a fixed radius, whereas in the former case, the effective ‘range’ of the communication is depending on the location of the ego client within its actual georegion (if it moved from North to South, then it had a first bigger range in the South direction, then bigger in the North direction). Similarly, to the improved geohash-based forwarding, this method also suffers from the issues from the simple geographic approach.
An application notification forwarding can calculate relevance based on safety applications. This approach calculates possible collisions between a vehicle and another object, or in the case of infrastructure messages, it checks whether the client resides in the relevance area of the message. Even though this approach limits the transmitted packets effectively, it still suffers from the issues of the geometry-based approaches. This approach also limits the achievable awareness on the client side; thus, the available applications as well.

The message routing method according to the invention can use map data to perform the routing mechanism. In connection with FIG. 10, it has already been discussed how an individual message can be matched to a map location. Here, the result of the map-matching is used to implement the routing method. The map-matching can be performed by any known ways. The routing method can work with several information sources, including the ego vehicle information, remote objects, map topology, and preferences from the client session. The method preferably first collects the ego information, the preferences of the client, and the map topology. The map-matching result of the ego (and also the remote ones) is known, because the algorithm works from an augmented object database. Then, based on the preferences and the ego information, a relevance distance or time is calculated (these can be interchangeable). The distance may be affected by the speed limit or other information on the road. The distance may be influenced by navigation information or the direction of the client as well (e.g., a different limit is applied to the front and the back). The distance is also influenced by the preferences of the client. Based on the relevance distance, a list of the available road sections is calculated using the map topology. The search may be implemented via the breadth-first search algorithm. Then, the remote objects are filtered based on the preferences of the client vehicle (e.g., if the ego is only interested in CAMs, then DENMs will be filtered out). Eventually, the objects on the relevant road sections are selected from the filtered relevant objects. Based on this information, the routing information (e.g., the message routing table) is updated. Either the messages can be sent directly to the ego, or some kind of routing configuration can be updated. This routing algorithm can also be combined with geometric approaches as well. For example, in the general case, a map-matching technique can be used, but we can also receive all objects in the proximity (e.g., 50 m).

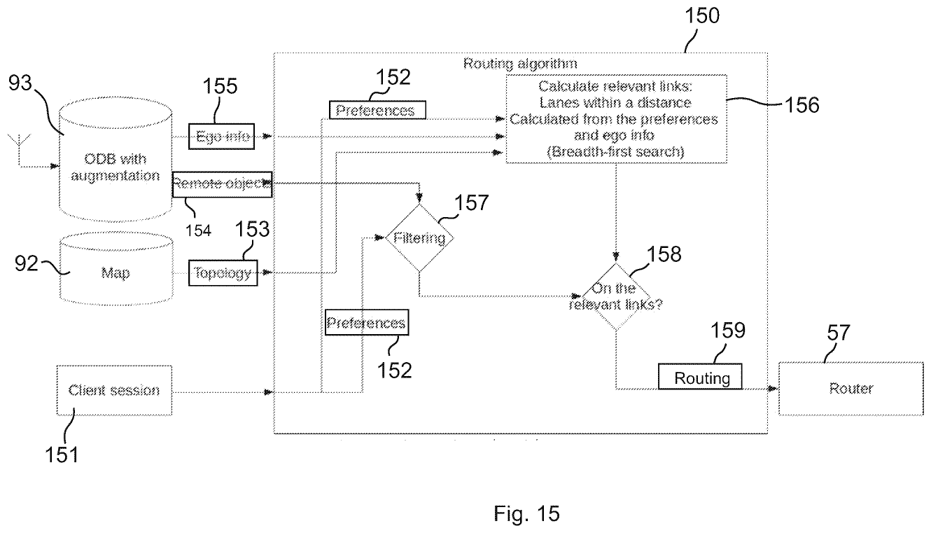

FIG. 15 shows a preferred embodiment of a routing algorithm 150 to be used in the method according to the invention.

Preferably, the routing algorithm receives information about an ego-vehicle, e.g., in a form of an ego-info 155, and also from one or more remote objects 154. Data regarding the ego-vehicle and the remote objects 154 can be stored in and retrieved from an object database (ODB) 93, preferably having augmented data. As a further input of the routing algorithm 150, topology data 153 needs to be provided, preferably from a map 92. It was already discussed that clients subscribed to the routing services might have different needs in connection with routing, e.g., depending on the level of automation of the vehicle, therefore it is preferred to provide the routing algorithm 150 with preferences 152 of the client, e.g., from a client session 151.

The routing algorithm 150 preferably has a relevant link calculating module 156 to calculate lanes within a distance of the ego-vehicle based on ego-info 155, preferences 152 and topology data 153.

The routing algorithm 150 preferably also includes a filtering module 157 to filter out irrelevant remote data (data of remote objects 154) and only keep remote data that fits the preferences 152 of the client (ego-vehicle).

After filtering out irrelevant remote data by the filtering module 157, it needs to be checked by a checking module 158 whether the remaining remote data is on the relevant link determined by the relevant link calculating module 156 or not. If a remote object 154 fits to the preferences 152 and is on the relevant link, then a routing 159 is established between the remote object 154 and the ego-vehicle, and this information is passed down to the message router 57.

The method according to the invention can be implemented in multiple ways. One possibility is an MQTT-based implementation, where the clients publish their messages to a topic which encodes the message type, direction and the station ID of the sender (e.g., v2xTx/cam/123456789; for infrastructure messages, other IDs can also be encoded, like the DENM ActionID or the intersection reference ID in MAPs and SPaTs). Then, the routing algorithm forwards the routing table to one or more dedicated MQTT clients which perform the message forwarding. The routing table contains the relevant station IDs for each client for each message type. The routing client subscribes to all transmitted (uplink) packets and repeats the messages to the relevant clients by addressing their subscription topic. For reception, each (non-routing) client has a topic to which it subscribes and which encodes its station id (e.g., v2xRx/12345678).

Another possible implementation can be RabbitMQ-based. In this scenario, instead of performing the message forwarding on a dedicated client, it is possible to configure queues on the broker. Then, the message routing can be performed via these queues.

FIG. 16 depicts an exemplary multi-domain implementation of message router instance handling.

The number of clients in a V2X application is changing continuously. Thanks to the recent advances in IT, especially in VNFs (Virtual Network Functions) and virtualization, a dynamic handling of application instances became available. These techniques also enhance the scalability. An orchestration module 162 can orchestrate the instances of the routing modules 163a, 163b. The orchestration module 162 includes but is not limited to health and load monitoring, instantiation, and instance termination. The orchestration module 162 also facilitates the roaming of the client sessions (the state of each client), both on the router 57 and client sides. The orchestrator does not necessarily implement the state roaming, it can also simply notify the actors so that they can implement the client state exchange. This decision is implementation dependent. The scope of the orchestrator includes but is not limited to the broker (the V2X application server) and the additional services (other V2X application services, like the aggregation service). The orchestration module 162 might include inter-MNO use cases as well, whereas it notifies the other MNOs, or the gateway implemented in the host network about the changed topology. The orchestration module 162 can also include a reconfiguration of the network slicing settings.

In the example of FIG. 16, an original domain 160, i.e., a geographical area is split into multiple subdomains (in this example a first and second subdomain 161a, 161b), and each subdomain has a respective routing module 163a, 163b, each including a message router 57, preferably equipped with a data service session handler 58 and implemented in a cloud or MEC server. The routing modules 163a, 163b are preferably communicate with their subscribed clients via wireless radio link 168, through which messages are exchanged. It is also necessary that the routing modules 163a, 163b communicate with each other; such a communication can be established via connection state roaming 166 (which can include slicing), and V2X message exchange links 167. To control the routing modules 163a, 163b, the system includes an orchestration module, that can receive load data 164 from each routing modules163a, 163b and that can send instantiation 165 to the routing modules 163a, 163b.

The invention, furthermore, relates to a computer program product comprising instructions which, when the program is executed by a computer, cause the computer to carry out an embodiment of the method according to the invention.

The computer program product may be executable by one or more computers.

The invention also relates to a computer readable medium comprising instructions which, when executed by a computer, cause the computer to carry out an embodiment of the method according to the invention.

The computer readable medium may be a single one or comprise more separate pieces.

The invention is, of course, not limited to the preferred embodiments described in detail above, but further variants, modifications and developments are possible within the scope of protection determined by the claims. Furthermore, all embodiments that can be defined by any arbitrary dependent claim combination belong to the invention.

### List of Reference Signs

10 relevance area
12 barrier
14 message routing centre
30 relevance area
32 barrier
42 barrier
50a, 50b, 50c vehicles
51a, 51b, 51c unicast radio links
52a, 52b, 52c,52d information
53 C-ITS server
55 wireless access point
56 server
57 message router
58 data service session handler
60 vehicle
61 Data Service Session Initiation Message
62 Data Service Session Initiation Response
63 Data Service Subscription Message
64 Data Service Subscription Response
65 Data Service Update Request Message
66 Data Service Update Response
67 Data Service Termination Request Message
68 Data Service Termination Response
71 unicast radio channel
72 barrier
73 server-side receiver module
74 topic
75 map-matching module
76 object database
77 map-aware filter
78 message router module
79 preference
80 V2X Application Server
81 V2X application
82a, 82b, 82c,82d User Equipment
83 V2X Control Function
84 Home Subscriber Server
85 Mobility Management Entity
86 Serving Gateway/Packet Data Network Gateway
88 Evolved UMTS Terrestrial Radio Access Network
89 V2X application specific server
90 Message feature extraction module
91 Map-matching module
92 map
93 object database
94 aggregation module
95a,95b,95c filtering module
96a,96b,96c routing module
97a, 97b, 97c preferences
100a, 100b V2X application specific client
110 bridge
112 road
115 affected area
120 additional services
121 HD map-based DENM generation module
122 MEC-based fusion module
123 path prediction module
124 map-matching module
125 further additional service module
150 routing algorithm
151 client session
152 preferences
153 topology data
154 remote object
155 ego-info
156 relevant link calculating module
157 filtering module
158 checking module
159 routing
160 original domain
161a first subdomain
161b second subdomain
162 orchestration module
163a, 163b routing module
164 load data
165 instantiation
166 connection state roaming
167 V2X message exchange link
168 wireless radio link

1. A method for message routing, the method comprising the steps of
receiving, by a message routing center, an incoming message from at least one source entity, wherein the incoming message includes traffic-related information,
transmitting, by the message routing center, an outgoing message to at least a receiving entity containing the traffic-related information of the incoming message if the incoming message is deemed relevant for the receiving entity, wherein relevance is determined by the message routing center based on map-matched location of the source entity and the receiving entity,
wherein
the message routing center has a message routing table, and
the method further comprises calculating values of the message routing table, wherein each value of the message routing table corresponds to relevance between a source entity and a receiving entity.

2. The method according to claim 1, further comprising a step of calculating a relevance area of the incoming message.

3. The method according to claim 2, wherein the relevance area comprises a road link corresponding to an actual location of the source entity.

4. The method according to claim 1, further comprising a step of updating the message routing table when a new source entity and/or a new receiving entity connects to the message routing center.

5. The method according to according to claim 1, wherein the message routing center calculates map-matched location of the sending entity and/or the receiving entity.

6. The method according to claim 1, wherein the message routing center receives multiple messages, generates a synthesized information based on the multiple messages and transmits a message including the synthesized information to relevant receiving entities based on the message routing table.

7. The method according to claim 1, further comprising a step of sending, by a message routing center, a control message to the sending entity to adjust its message sending frequency.

8. The method according to claim 1, wherein the source entity is a vehicle and/or an infrastructure element.

9. The method according to claim 1, wherein the incoming message is part of a data stream.

10. A computer system adapted to performing the steps of the method according to claim 1, the system comprising
a message routing center adapted to receiving an incoming message from at least one source entity, wherein the incoming message includes traffic-related information and transmitting an outgoing message to at least a receiving entity containing the traffic-related information of the incoming message if the incoming message is deemed relevant for the receiving entity, wherein relevance is determined by the message routing center based on map-matched location of the source entity and the receiving entity
wherein
the message routing center has a message routing table, and each value of the message routing table corresponds to relevance between a source entity and a receiving entity.

11. The system according to claim 10, wherein the message routing further comprises a map-matching module.

12. The system according to claim 10, wherein the message routing center further comprises an object database.

13. The system according to claim 10, wherein the message routing center further comprises an aggregation module for combining information of multiple incoming messages.

14. The system according to claim 10, further comprising a data service session handler for handling subscription of new source and/or receiving entities, managing subscriptions, and/or terminating subscriptions, wherein the data service session handler is included in or connected to the message routing center.

15. A non-transitory computer program product comprising instructions which, when the program is executed by a computer, cause the computer to carry out the method of claim 1.

16. A non-transitory computer readable medium comprising instructions which, when executed by a computer, cause the computer to carry out the method of claim 1.
